(19) United States
(12) Patent Application Publication
(10) Pub. No.: US 2025/0109256 A1
(43) Pub. Date: Apr. 3, 2025

(54) SILICONE RUBBER COMPOSITION

(71) Applicant: DOW SILICONES CORPORATION, Midland, MI (US)

(72) Inventors: Rui WANG, Shanghai (CN); Peng WANG, Shanghai (CN); Jinxia MA, Zhangjiagang, Jiangsu (CN); Yusheng CHEN, Shanghai (CN)

(21) Appl. No.: 18/709,670

(22) PCT Filed: Nov. 19, 2021
(86) PCT No.: PCT/CN2021/131641

§ 371 Date: May 13, 2024

(51) Int. Cl. C08G 77/20; C08G 77/08; C08G 77/12; C08K 5/00; C08K 5/25; C08K 5/3472; C08K 5/37; C08K 7/26; H01B 3/46; H01B 7/02; H01B 13/14

(52) U.S. Cl. CPC C08G 77/20; C08G 77/08; C08G 77/12; C08K 5/0091; C08K 5/25; C08K 5/3472; C08K 5/37; C08K 7/26; H01B 3/46; H01B 7/0225; H01B 13/14

(57) ABSTRACT

Hydrosilylation (addition) curable heat stabilised silicone rubber compositions, silicone rubber elastomers made upon cure of the compositions and their applications and uses are disclosed. The heat stabiliser additives utilised in the compositions comprise one or more of dodecanedioic acid, bis[2-(2-hydroxybenzoyl)hydrazide], 1,2-di[-(3,5-di-tert-butyl-4-hydroxyphenyl)propionyl]hydrazine, metal or non-metal phthalocyanine complexes, salicyloylaminotriazole, triazole, benzotriazole, dilauryl 3,3′-thiodipropionate, ditridecyl 3,3′-thiodipropionate, diphenyl sulfide, and/or pentaerythritol beta-laurylthiopropionate.

The present disclosure relates to hydrosilylation (addition) curable heat stabilised silicone rubber compositions, silicone rubber elastomers made upon the cure of said compositions and their applications and uses.

Hydrosilylation curable silicone rubber compositions that contain organopolysiloxane polymers having unsaturated (alkenyl and/or alkynyl) groups and compounds containing silicon-bonded hydrogen atoms curable by a hydrosilylation reaction in the presence of a hydrosilylation catalyst are known in the art.

Whilst such compositions are usually stored prior to use in two or more parts to prevent premature cure, they have the following advantages over radical (i.e., peroxide) reaction curable silicone rubber compositions which tend to be used when the silicone polymer is a high viscosity silicone gum:
they can cure faster and at lower temperatures;
the cure process is substantially odorless;
the cure process doesn't usually require post cure treatments; and
the resulting elastomers usually have a higher tear strength.

It is known that said hydrosilylation curable silicone rubber compositions may have their heat stability improved by the introduction of one or more inorganic heat stabilizers, such as hydrated cerium oxide, hydrated aluminum oxide, cerium hydroxide, red iron oxide, carbon black, graphite and zinc oxide used alone or in combination.

Silicone elastomeric products cured from the above compositions are used in a variety of fields due to their excellent physical and heat stability properties. For example, silicone elastomeric products made from such compositions are used in a variety of high temperature applications due to their excellent heat stability compared with organic based rubbers. Applications include, for the sake of example, electronics where they tend to be used to coat/encapsulate solid state electronic devices such as transistors, integrated circuits and circuit boards and increasingly in both automotive applications and power supply applications, e.g., for power cable insulation.

Hence, increasingly hydrosilylation curable silicone rubber compositions are being used for power cable insulation purposes in electric vehicles (EVs) and/or hybrid electric vehicles (HEVs). The hydrosilylation curable silicone rubber compositions described above can be extruded onto large-diameter, high-voltage power cables to provide a continuous outer sheath over the cable.

Such high-voltage power cables are used in EVs and HEVs for connecting the charging port and the battery and for inter-wiring the battery and the engine via an inverter, where low-voltage power is transferred from the battery module/pack to an inverter where the voltage is amplified to a significantly greater voltage say 500 V or higher and then on to the drive motor in order to provide power over sustained periods of time to enable acceptably long journeys between recharges. Furthermore, HEV and EV power cables can be exposed to heat from other sources in an engine such as exhausts; therefore, the ability to maintain sufficient heat stability for an extended period of time is a critical feature of such cables.

The power cables are required to meet very high performance requirements, in accordance with international standards due to the harsh environments in which they are situated inside vehicles given the increasing demands from manufacturers of HEVs and EVs. For example, the increase in working voltage platform of EV and HEV battery modules and/or battery packs require the high voltage cables to have superior heat aging performance and to pass class E requirements with respect to ISO 6722 and LV 216 standards, i.e., the ability to withstand long term heat aging at 175 or 180° C. for 3,000 hours and short-term heat aging at 200° C. for 240 hours and after said aging the resulting aged cable still needs to pass winding tests.

There is provided herein a hydrosilylation curable heat stabilised silicone rubber composition, which comprises the following components:
a) an organopolysiloxane polymer having a William's plasticity of at least 100 mm/100 measured in accordance with ASTM D-926-08; and at least two unsaturated groups per molecule, which unsaturated groups are selected from alkenyl or alkynyl groups;
b) reinforcing silica filler;
c) a linear or branched organopolysiloxane filler treating agent comprising multiple units of the structure:

—((R¹⁰)₂SiO)—,
where each R¹⁰ may be the same or different and is an alkyl group having from 1 to 10 carbons, alternatively an alkyl group having 1 to 6 carbons, or is an aromatic group having from 6 to 12 carbons and the number average degree of polymerization is in a range of between 1 to 50, and where each terminal group comprises at least one hydroxyl or alkoxy;
d) an organosilicon compound having at least two, alternatively at least three Si—H groups per molecule,
e) a heat stabiliser additive selected from one or more of dodecanedioic acid, bis[2-(2-hydroxybenzoyl)hydrazide], 1,2-di[-(3,5-di-tert-butyl-4-hydroxyp-henyl)propionyl]hydrazine, metal or non-metal phthalocyanine complexes, salicyloylaminotriazole, triazole, benzotriazole, dilauryl 3,3′-thiodipropionate, ditridecyl 3,3′-thiodipropionate, diphenyl sulfide and/or pentaerythritol beta-laurylthiopropionate; and
f) a hydrosilylation catalyst comprising or consisting of a platinum group metal or a compound thereof.

There is also a process described herein for the preparation of a hydrosilylation cured heat stabilised silicone rubber comprising the steps of
(i) preparing a silicone rubber base composition comprising
   a) an organopolysiloxane polymer having a William's plasticity of at least 100 mm/100 measured in accordance with ASTM D-926-08; and at least two unsaturated groups per molecule, which unsaturated groups are selected from alkenyl or alkynyl groups;
   b) reinforcing silica filler; and
   c) a linear or branched organopolysiloxane filler treating agent comprising multiple units of the structure:

—((R¹⁰)₂SiO)—,
where each R¹⁰ may be the same or different and is an alkyl group having from 1 to 10 carbons, alternatively an alkyl group having 1 to 6 carbons, or is an aromatic group having from 6 to 12 carbons and the number average degree of polymerization is in a range of between 1 to 50, and where each terminal group comprises at least one hydroxyl or alkoxy;
(ii) mixing into the silicone rubber base of step (i)
   d) an organosilicon compound having at least two, alternatively at least three Si—H groups per molecule,
   e) a heat stabiliser additive selected from one or more of dodecanedioic acid, bis[2-(2-hydroxybenzoyl)hydrazide], 1,2-di[-(3,5-di-tert-butyl-4-hydroxyp-henyl)propionyl]hydrazine, metal or non-metal phthalocyanine complexes, salicyloylaminotriazole, triazole, benzotriazole, dilauryl 3,3′-thiodipropionate, ditridecyl 3,3′-thiodipropionate, diphenyl sulfide and/or pentaerythritol beta-laurylthiopropionate; and simultaneously or subsequently
f) a hydrosilylation catalyst comprising or consisting of a platinum group metal or a compound thereof; and
(iii) curing the composition.

There is also provided herein a use of an additive e) selected from one or more of dodecanedioic acid, bis[2-(2-hydroxybenzoyl)hydrazide], 1,2-di[-(3,5-di-tert-butyl-4-hydroxyp-henyl)propionyl]hydrazine, metal or non-metal phthalocyanine complexes, Salicyloylaminotriazole, triazole, benzotriazole, dilauryl 3,3′-thiodipropionate, ditridecyl 3,3′-thiodipropionate, Diphenyl sulfide and/or pentaerythritol beta-laurylthiopropionate as a or the heat stabilizer in a composition otherwise comprising the following components:
a) an organopolysiloxane polymer having a William's plasticity of at least 100 mm/100 measured in accordance with ASTM D-926-08; and at least two unsaturated groups per molecule, which unsaturated groups are selected from alkenyl or alkynyl groups;
b) reinforcing silica filler;
c) a linear or branched organopolysiloxane filler treating agent comprising multiple units of the structure:

—((R¹⁰)₂SiO)—,
where each R¹⁰ may be the same or different and is an alkyl group having from 1 to 10 carbons, alternatively an alkyl group having 1 to 6 carbons, or is an aromatic group having from 6 to 12 carbons and the number average degree of polymerization is in a range of between 1 to 50, and where each terminal group comprises at least one hydroxyl or alkoxy;
d) an organosilicon compound having at least two, alternatively at least three Si—H groups per molecule,
and
f) a hydrosilylation catalyst comprising or consisting of a platinum group metal or a compound thereof;

There is also provided herein an electrical power cable comprising
an electrically conductive core;
one or more layers of insulation around said core and
an outer sheath made from the heat stabilised silicone rubber being the cured product of the above composition.

There is also provided herein the use of heat stabilised silicone rubber being the cured product of the above composition as an outer sheath for an electrical power cable.

There is also provided herein a method for preparing an electrical power cable comprising the step of applying and curing an outer sheath around the cable wherein said outer sheath is the cured product of the above composition hereinbefore described.

In each case the total weight (wt.) % of each composition shown herein is 100 wt. %.

It was surprisingly identified that the use of additives (e) in the above composition improved short term (240 hours at 200° C.) and long term (3000 hours at 180° C.) heat stability in hydrosilylation curable compositions using silicone gums (having a viscosity of greater than 1,000,000 mPa·s at 25° C.) i.e., having a William's plasticity of at least 100 mm/100 measured in accordance with ASTM D-926-08 as described above. More importantly it allowed such compositions to pass class E for international standard heat stability tests ISO 6722 and LV 216 standards (long term heat aging at 175 or 180° C. for 3,000 hours and short-term heat aging at 200° C. for 240 hours.

The components of the composition are as follows:

### Component (a)

Component (a) is an organopolysiloxane polymer having a William's plasticity of at least 100 mm/100 measured in accordance with ASTM D-926-08; and at least two unsaturated groups per molecule. The unsaturated groups are selected from alkenyl and/or alkynyl groups.

Each organopolysiloxane polymer of component (a) comprises multiple siloxy units, of formula (I):

R′ₐSiO_{(4-a)/2} (I)

The subscript “a” is 0, 1, 2 or 3.

Siloxy units may be described by a shorthand (abbreviated) nomenclature, namely—“M,” “D,” “T,” and “Q”, when R′ is as described above, alternatively an alkyl group, typically a methyl group. The M unit corresponds to a siloxy unit where a=3, that is R′₃SiO₁,2; the D unit corresponds to a siloxy unit where a=2, namely R′₂SiO_{2/2}; the T unit corresponds to a siloxy unit where a=1, namely R′₁SiO_{3/2}; the Q unit corresponds to a siloxy unit where a=0, namely SiO_{4/2}. The organopolysiloxane polymer of component (a) is substantially linear but may contain a proportion of branching due to the presence of T units (as previously described) within the molecule, hence the average value of a in structure (I) is about 2.

The unsaturated groups of component (a) may be positioned either terminally or pendently on the organopolysiloxane polymer, or in both locations. The unsaturated groups of component (a) may be alkenyl groups or alkynyl groups as described above. Each alkenyl group, when present, may comprise for example from 2 to 30, alternatively 2 to 24, alternatively 2 to 20, alternatively 2 to 12, alternatively 2 to 10, and alternatively 2 to 6 carbon atoms. When present the alkenyl groups may be exemplified by, but not limited to, vinyl, allyl, methallyl, isopropenyl, propenyl, and hexenyl and cyclohexenyl groups. Each alkynyl group, when present, may also have 2 to 30, alternatively 2 to 24, alternatively 2 to 20, alternatively 2 to 12, alternatively 2 to 10, and alternatively 2 to 6 carbon atoms. Examples of alkynyl groups may be exemplified by, but not limited to, ethynyl, propynyl, and butynyl groups. Preferred examples of the unsaturated groups of component (a) include vinyl, propenyl, isopropenyl, butenyl, allyl, and 5-hexenyl.

In formula (I), each R′, other than the unsaturated groups described above, is independently selected from an aliphatic hydrocarbyl group, a substituted aliphatic hydrocarbyl group, an aromatic group or a substituted aromatic group. Each aliphatic hydrocarbyl group may be exemplified by, but not limited to, alkyl groups having from 1 to 20 carbons per group, alternatively 1 to 15 carbons per group, alternatively 1 to 12 carbons per group, alternatively 1 to 10 carbons per group, alternatively 1 to 6 carbons per group or cycloalkyl groups such as cyclohexyl. Specific examples of alkyl groups may include methyl, ethyl, propyl, pentyl, octyl, undecyl, and octadecyl groups, alternatively methyl and ethyl groups. Substituted aliphatic hydrocarbyl group are preferably non-halogenated substituted alkyl groups.

The aliphatic non-halogenated organyl groups are exemplified by, but not limited to alkyl groups as described above with a substituted group such as suitable nitrogen containing groups e.g. amido groups or imido groups; oxygen containing groups such as polyoxyalkylene groups, carbonyl groups, alkoxy groups and hydroxyl groups. Further organyl groups may include sulfur containing groups, phosphorus containing groups, boron containing groups. Examples of aromatic groups or substituted aromatic groups are phenyl groups and substituted phenyl groups with substituted groups as described above.

Component (a) may, for example, be selected from polydimethylsiloxanes, alkylmethylpolvsiloxanes, alkylarylpolysiloxanes or copolymers thereof (where reference to alkyl means any suitable alkyl group, alternatively an alkyl group having two or more carbons) providing each polymer contains at least two unsaturated groups, typically alkenyl groups as described above and has a degree of polymerisation of at least 2,500. They may for example be trialkyl terminated, alkenyldialkyl terminated alkynyldialkyl terminated or may be terminated with any other suitable terminal group combination providing each polymer has a William's plasticity of at least 100 mm/100 measured in accordance with ASTM D-926-08 and at least two unsaturated groups.

Hence component (a) may, for the sake of example, be:
a dialkylalkenyl terminated polydimethylsiloxane, e.g. dimethylvinyl terminated polydimethylsiloxane; a dialkylalkenyl terminated dimethylmethylphenylsiloxane, e.g. dimethylvinyl terminated dimethylmethylphenylsiloxane; a trialkyl terminated dimethylmethylvinyl polysiloxane; a dialkylvinyl terminated dimethylmethylvinyl polysiloxane copolymer; a dialkylvinyl terminated methylphenylpolysiloxane, a dialkylalkenyl terminated methylvinylmethylphenylsiloxane; a dialkylalkenyl terminated methylvinyldiphenylsiloxane; a dialkylalkenyl terminated methylvinyl methylphenyl dimethylsiloxane; a trimethyl terminated methylvinyl methylphenylsiloxane; a trimethyl terminated methylvinyl diphenylsiloxane; or a trimethyl terminated methylvinyl methylphenyl dimethylsiloxane.

In each case component (a) has a William's plasticity of at least 100 mm/100 measured in accordance with ASTM D-926-08. Organopolysiloxane polymers of this magnitude are generally referred to in the industry as organopolysiloxane polymer gums, siloxane gums or silicone gums (hereafter referred to as a silicone gum) because of their very high viscosity (at least 1,000,000 mPa·s at 25° C., often many millions mPa·s at 25° C.) and high molecular weight. Because of the difficulty in measuring the viscosity of such highly viscous fluids silicone gums, tend to be defined by way of their William's plasticity values as opposed to by viscosity. Component (a) is a silicone gum and has a William's plasticity of at least 100 mm/100 measured in accordance with ASTM D-926-08, alternatively at least 125 mm/100 measured in accordance with ASTM D-926-08, alternatively at least 140 mm/100 measured in accordance with ASTM D-926-08. Typically, silicone gums have a William's plasticity of from about 100 mm/100 to 300 mm/100 measured in accordance with ASTM D-926-08.

The number average molecular weight (Mn) and weight average molecular weight (Mw) of such polymers are typically determined by gel permeation chromatography using polystyrene standards. In the present disclosure the number average molecular weight and weight average molecular weight values of the silicone gums used as component (a) herein were determined using a Waters 2695 Separations Module equipped with a vacuum degasser, and a Waters 2414 refractive index detector (Waters Corporation of MA. USA). The analyses were performed using certified grade toluene flowing at 1.0 mL/min as the eluent. Data collection and analyses were performed using Waters Empower GPC software.

The degree of polymerisation of the polymer was approximately the number average molecular weight of the polymer divided by 74 (the molecular weight of one component (I) depicted above). Typically, the alkenyl and/or alkynyl content, e.g. vinyl content of the polymer is from 0.01 to 3 wt. % for each organopolysiloxane polymer containing at least two silicon-bonded alkenyl groups per molecule of component (a), alternatively from 0.01 to 2.5 wt. % of component (a), alternatively from 0.01 to 2.0 wt. %, alternatively from 0.01 to 1.5 wt. % of component (a) of the or each organopolysiloxane polymer containing at least two unsaturated groups per molecule, which unsaturated groups are selected from alkenyl or alkynyl groups per molecule of component (a). The alkenyl/alkynyl content of component (a) is determined using quantitative infra-red analysis in accordance with ASTM E168.

Component (a) may be present in the composition in an amount of from 40 wt. % to about 90 wt. % of the composition, alternatively from 45 to 85 wt. % of the composition, alternatively from 50 to 80 wt. % of the composition. Typically, component (a) is present in an amount which is the difference between 100 wt. % and the cumulative wt. % of the other components/ingredients of the composition.

### Component (b)

Component (b) is at least one reinforcing silica filler. Preferably said reinforcing silica fillers are in a finely divided form. The reinforcing silica fillers (b) may be exemplified by fumed silica, colloidal silicas and/or a precipitated silica.

Precipitated silica, fumed silica and/or colloidal silicas are particularly preferred because of their relatively high surface area, which is typically at least 50 m²/g (BET method in accordance with ISO 9277: 2010); alternatively, having surface areas of from 50 to 450 m²/g (BET method in accordance with ISO 9277: 2010), alternatively having surface areas of from 50 to 300 m²/g (BET method in accordance with ISO 9277: 2010), are typically used. All these types of silica are commercially available.

The reinforcing silica filler(s) of component (b) are naturally hydrophilic and are treated with one or more treating agents (c) to render them hydrophobic. These surface modified reinforcing fillers of component (b) do not clump and can be homogeneously incorporated into organopolysiloxane polymer (a), described below, as the surface treatment makes the fillers easily wetted by organopolysiloxane polymer (a).

Component (b) is present in an amount of up to 50 wt. % of the composition, alternatively from 1.0 to 50 wt. % of the composition, alternatively of from 5.0 to 45 wt. % of the composition, alternatively of from 10.0 to 40 wt. % of the composition.

### Component (c)

The reinforcing silica fillers (b) are hydrophobically treated by treatment with component (c). Component (c) of the composition herein comprises a short chain linear or branched polydiorganosiloxane which is dialkylhydroxy or dialkylalkoxy terminated, which short chain linear or branched polydiorganosiloxane comprise multiple units of the structure:

—((R¹⁰)₂SiO)—,

where each R¹⁰ may be the same or different and is an alkyl group having from 1 to 10 carbons, alternatively an alkyl group having 1 to 6 carbons, alternatively is methyl, ethyl or propyl or is an aromatic group having from 6 to 12 carbons, alternatively phenyl, and the number average degree of polymerization is in a range of between 2 to 50, alternatively 2 to 25. In one embodiment each R¹⁰ is selected from methyl, ethyl, propyl and phenyl. Each terminal alkoxy group, when present, typically has from 1 to 6 carbons but is preferably ethoxy or methoxy. Hence, the short chain linear or branched polydiorganosiloxane may be selected from a dimethylhydroxy terminated polydimethylsiloxane, a dimethylmethoxy terminated polydimethylsiloxane or a dimethylethoxy terminated polydimethylsiloxane where the number average degree of polymerization is from 2 to 25, alternatively from 2 to 20; a dimethylhydroxy terminated polymethylphenylsiloxane a dimethylmethoxy terminated polymethylphenylsiloxane or a dimethylethoxy terminated polymethylphenylsiloxane where the number average degree of polymerization is from 2 to 25, alternatively from 5 to 20, and/or a dimethylhydroxy terminated polydimethylmethylphenylsiloxane copolymer, dimethylmethoxy terminated polydimethylmethylphenylsiloxane copolymer or a dimethylethoxy terminated polydimethvlmethylphenvlsiloxane copolymer where the number average degree of polymerization is from 2 to 25, alternatively from 2 to 20; for example

HO—((R¹⁰)₂SiO)ₓ—H

Where x is the number average degree of polymerization

Molecular weight values may again be determined by gel permeation chromatography but polymers at the lower end of the range e.g., having a DP of from about 2 to 20 can be analysed by gas chromatography-mass spectroscopy (GC-MS).

The surface treatment of untreated reinforcing fillers of component (b) may be undertaken prior to introduction in the composition or in situ (i.e., in the presence of at least a portion of the other ingredients of the composition herein by blending these ingredients together at room temperature or above until the filler is completely treated. Typically, untreated reinforcing filler (b) is treated in situ with a treating agent comprising or consisting of component (c) in the presence of organopolysiloxane polymer (a) which results in the preparation of a silicone rubber base material which can subsequently be mixed with other ingredients. Component (c) may be present in the composition in an amount of from 0.1 to 20 wt. % of the composition, alternatively 0.5 to 15, wt. % of the composition, alternatively 1 to 10, wt. % of the composition.

### Component (d)

Component (d) functions as a cross-linker and is provided in the form of an organosilicon compound having at least two, alternatively at least three Si—H groups per molecule. Component (d) normally contains three or more silicon-bonded hydrogen atoms so that the hydrogen atoms can react with the unsaturated alkenyl and/or alkynyl groups of component (a) to form a network structure therewith and thereby cure the composition. Some or all of Component (d) may alternatively have two silicon bonded hydrogen atoms per molecule when polymer (a) has greater than two unsaturated groups per molecule.

The molecular configuration of the organosilicon compound having at least two, alternatively at least three Si—H groups per molecule (d) is not specifically restricted, and it can be a straight chain, branched (a straight chain with some branching through the presence of T groups), cyclic or silicone resin based.

While the molecular weight of component (d) is not specifically restricted, the viscosity is typically from 5 to 50,000 mPa·s at 25° C. relying as measured using TA instruments AR2000 Rheometer in plate-plate model at shear rate 10 s⁻¹, in order to obtain a good miscibility with polymer (a).

Silicon-bonded organic groups used in component (d) may be exemplified by alkyl groups such as methyl, ethyl, propyl, n-butyl, t-butyl, pentyl, hexyl; aryl groups such as phenyl tolyl, xylyl, or similar aryl groups; 3-chloropropyl, 3,3,3-trifluoropropyl, or similar halogenated alkyl group, preferred alkyl groups having from 1 to 6 carbons, especially methyl ethyl or propyl groups or phenyl groups. Preferably the silicon-bonded organic groups used in component (b) are alkyl groups, alternatively methyl, ethyl or propyl groups.

Examples of the organosilicon compound having at least two, alternatively at least three Si—H groups per molecule (d) include but are not limited to:
(a) trimethylsiloxy-terminated methylhydrogenpolysiloxane,
(b) trimethylsiloxy-terminated polydimethylsiloxane-methylhydrogensiloxane,
(c) dimethylhydrogensiloxy-terminated dimethylsiloxane-methylhydrogensiloxane copolymers,
(d) dimethylsiloxane-methylhydrogensiloxane cyclic copolymers,
(e) copolymers and/or silicon resins consisting of (CH₃)₂HSiO_{1/2} units, (CH₃)₃SiO_{1/2} units and SiO_{4/2} units,
(f) copolymers and/or silicone resins consisting of (CH₃)₂HSiO_{1/2} units and SiO_{4/2} units,
(g) Methylhydrogensiloxane cyclic homopolymers having between 3 and 10 silicon atoms per molecule;
alternatively, component (d), the cross-linker, may be a filler, e.g., silica treated with one of the above, and mixtures thereof.

In one embodiment the Component (d) is selected from a methylhydrogenpolysiloxane capped at both molecular terminals with trimethylsiloxy groups; a copolymer of a methylhydrogensiloxane and a dimethylsiloxane capped at both molecular terminals with trimethylsiloxy groups; dimethylsiloxane capped at both molecular terminals with dimethylhydrogensiloxy groups; a copolymer of a methylhydrogensiloxane and a dimethylsiloxane capped at both molecular terminals with dimethylhydrogensiloxy groups.

The cross-linker (d) is generally present in the hydrosilylation curable heat stabilised silicone rubber composition such that the molar ratio of the total number of the silicon-bonded hydrogen atoms in component (d) to the total number of alkenyl and/or alkynyl groups in polymer (a) or in the composition if different is from 0.5:1 to 20:1. When this ratio is less than 0.5:1, a well-cured composition will not be obtained. When the ratio exceeds 20:1, there is a tendency for the hardness of the cured composition to increase when heated. Preferably in an amount such that the molar ratio of silicon-bonded hydrogen atoms of component (d) to alkenyl/alkynyl groups, alternatively alkenyl groups of component (a) or in the composition ranges from 0.7:1.0 to 5.0:1.0, preferably from 0.9:1.0 to 2.5:1.0, and most preferably from 0.9:1.0 to 2.0:1.0.

The silicon-bonded hydrogen (Si—H) content of component (d) is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V].

Typically, dependent on the number of unsaturated groups in component (a) as well as the number of Si—H groups in component (d), component (d) will be present in an amount of from 0.1 to 10 wt. % of the hydrosilylation curable heat stabilised silicone rubber composition, alternatively 0.1 to 7.5 wt. % of the hydrosilylation curable heat stabilised silicone rubber composition, alternatively 0.5 to 7.5 wt. %, further alternatively from 0.5% to 5 wt. % of the hydrosilylation curable heat stabilised silicone rubber composition.

### Component (e)

Component (e) a heat stabiliser additive selected from one or more of dodecanedioic acid, bis[2-(2-hydroxybenzoyl)hydrazide], 1,2-di[-(3,5-di-tert-butyl-4-hydroxyphenyl)propionyl]hydrazine, dilauryl 3,3′-thiodipropionate, ditridecyl 3,3′-thiodipropionate, diphenyl sulfide, pentaerythritol beta-laurylthiopropionate, metal or non-metal phthalocyanine complexes, salicyloylaminotriazole, triazole, benzotriazole, and mixtures thereof. Component (e) may be present in the composition in an amount of from 0.001 to 5 wt. % of the composition, alternatively of from 0.01 to 5 wt. % of the composition, alternatively 0.01 to 3 wt. % of the composition.

### Component (t)

Component (f) of the hydrosilylation curable heat stabilised silicone rubber composition, is a hydrosilylation catalyst comprising or consisting of a platinum group metal or a compound thereof. These are usually selected from catalysts of the platinum group of metals (platinum, ruthenium, osmium, rhodium, iridium and palladium), or a compound of one or more of such metals. Alternatively, platinum and rhodium compounds are preferred due to the high activity level of these catalysts in hydrosilylation reactions, with platinum compounds most preferred. In a hydrosilylation (or addition) reaction, a hydrosilylation catalyst such as component (f) herein catalyses the reaction between an unsaturated group, usually an alkenyl group e.g., vinyl with Si—H groups.

The hydrosilylation catalyst of component (f) can be a platinum group metal, a platinum group metal deposited on a carrier, such as activated carbon, metal oxides, such as aluminum oxide or silicon dioxide, silica gel or powdered charcoal, or a compound or complex of a platinum group metal. Preferably the platinum group metal is platinum.

Examples of preferred hydrosilylation catalysts of component (f) are platinum based catalysts, for example, platinum black, platinum oxide (Adams catalyst), platinum on various solid supports, chloroplatinic acids, e.g. hexachloroplatinic acid (Pt oxidation state IV) (Speier catalyst), chloroplatinic acid in solutions of alcohols e.g. isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g. tetra-vinyl-tetramethylcyclotetrasiloxane-platinum complex (Ashby catalyst). Soluble platinum compounds that can be used include, for example, the platinum-olefin complexes of the formulae (PtCl₂·(olefin)₂ and H(PtCl₃·olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution. Platinum catalysts with phosphorus, sulfur, and amine ligands can be used as well, e.g. (Ph₃P)₂PtCl₂; and complexes of platinum with vinylsiloxanes, such as sym-divinyltetramethyldisiloxane.

Hence, specific examples of suitable platinum-based catalysts of component (f) include
(i) complexes of chloroplatinic acid with organosiloxanes containing ethylenically unsaturated hydrocarbon groups are described in U.S. Pat. No. 3,419,593
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer. Solvents such as toluene and the like organic solvents have been used historically as alternatives but the use of vinyl siloxane polymers by far the preferred choice. These are described in U.S. Pat. Nos. 3,715,334 and 3,814,730. In one preferred embodiment component (f) may be selected from co-ordination compounds of platinum. In one embodiment hexachloroplatinic acid and its conversion products with vinyl-containing siloxancs, Karstedt's catalysts and Speier catalysts are preferred.

The catalytic amount of the hydrosilylation catalyst is generally between 0.01 ppm, and 10,000 parts by weight of platinum-group metal, per million parts (ppm), based on the weight of the composition; alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst is provided e.g., in a polymer or solvent, the amount of component (f) present will be within the range of from 0.001 to 3.0 wt. % of the composition, alternatively from 0.001 to 2.5 wt. % of the composition, alternatively 0.01 to 2.0 wt. %, of the hydrosilylation curable heat stabilised silicone rubber composition.

### Additional Optional Components

Additional optional components may be present in the hydrosilylation curable heat stabilised silicone rubber composition as hereinbefore described depending on the intended final use thereof. Examples of such optional components include cure inhibitors, compression set additives, additional hydrophobic treating agents other than component (c),pigments and/or coloring agents, and other additional additives such as pot life extenders, flame retardants, mold release agents, UV light stabilizers, bactericides, and mixtures thereof.

### Optional Hydrosilylation Reaction Inhibitors

The hydrosilylation curable heat stabilised silicone rubber composition as described herein may also comprise one or more optional hydrosilylation reaction inhibitors. Hydrosilylation reaction inhibitors are used, when required, to prevent or delay the hydrosilylation reaction inhibitors curing process especially during storage. The optional hydrosilylation reaction inhibitors of platinum-based catalysts are well known in the art and include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

One class of known hydrosilylation reaction inhibitors are the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 1-phenyl-2-propyn-1-ol, 3,5-dimethyl-1-hexyn-3-ol, 1-ethynylcyclopentanol, 3-methyl-1-penten-4-yn-3-ol, and mixtures thereof. Derivatives of acetylenic alcohol may include those compounds having at least one silicon atom. When present, hydrosilylation reaction inhibitor concentrations may be as low as 1 mole of hydrosilylation reaction inhibitor per mole of the metal of catalyst (f) will, in some instances, still impart satisfactory storage stability and cure rate. In other instances, hydrosilylation reaction inhibitor concentrations of up to 500 moles of inhibitor per mole of the metal of catalyst are required. The optimum concentration for a given hydrosilylation reaction inhibitor in a given composition is readily determined by routine experimentation. Dependent on the concentration and form in which the hydrosilylation reaction inhibitor selected is provided/available commercially, when present in the composition, the inhibitor is typically present in an amount of from 0.0125 to 10 wt. % of the composition.

In one embodiment the inhibitor, when present, is selected from 1-ethynyl-1-cyclohexanol (ETCH) and/or 2-methyl-3-butyn-2-ol and is present in an amount of greater than zero to 0.1 wt. % of the composition.

### Optional Additional Hydrophobing Treating Agents

The reinforcing silica filler(s) are treated herein with component (c) as hereinbefore discussed. Optionally additional hydrophobing agents may be utilised, for example, organosilanes, or organosilazanes e.g., hexaalkyl disilazane and short chain methyl vinyl siloxane diols. Specific examples include, but are not restricted to, silanol terminated trifluoropropylmethylsiloxane, silanol terminated vinyl methyl (ViMe) siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and tetramethyldi(trifluoropropyl)disilazane; hydroxyldimethyl terminated polydimethylmethylvinyl siloxane, octamethyl cyclotetrasiloxane, and silanes including but not limited to methyltrimethoxysilane, dimethyldimethoxysilane, vinyltrimethoxysilane, methyltriethoxysilane, vinyltriethoxysilane, chlrotrimethyl silane, dichlrodimethyl silane, trichloromethyl silane. In one embodiment, the treating agent may be selected from silanol terminated vinyl methyl (ViMe) siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and; hydroxyldimethyl teninated polydimethylmethylvinyl siloxane, octamethyl cyclotetrasiloxane, and silanes including but not limited to methvltriethoxysilane, dimethyldiethoxysilane and/or vinyltriethoxysilane. A small amount of water can be added together with the silica treating agent(s) as processing aid.

### Optional Pigments/Colorants

The hydrosilylation curable heat stabilised silicone rubber composition as described herein may further comprise one or more pigments and/or colorants which may be added if desired. The pigments and/or colorants may be coloured, white, black, metal effect, and luminescent e.g. fluorescent and phosphorescent.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

The pigments and/or colorants, when present, are present in the range of from 2 wt. %, alternatively from 3 wt. %, alternatively from 5 wt. % of the composition to 15 wt. % of the composition, alternatively to 10 wt. % of the composition.

Another optional additive herein may include pot life extenders, such as triazole, may be used, but are not considered necessary in the scope of the present invention. The hydrosilylation curable heat stabilised silicone rubber composition may thus be free of pot life extender.

Examples of flame retardants include aluminium trihydrate, chlorinated paraffins, hexabromocyclododecane, triphenyl phosphate, dimethyl methylphosphonate, tris(2,3-dibromopropyl) phosphate (brominated tris), and mixtures or derivatives thereof.

Hence, in one alternative, the present disclosure thus provides a hydrosilylation curable heat stabilised silicone rubber composition, which comprises:
a) an organopolysiloxane polymer having a William's plasticity of at least 100 mm/100 measured in accordance with ASTM D-926-08, alternatively at least 125 mm/100 measured in accordance with ASTM D-926-08, alternatively at least 140 mm/100 measured in accordance with ASTM D-926-08, with a maximum William's plasticity of from about 300 mm/100 measured in accordance with ASTM D-926-08, and at least two unsaturated groups per molecule, which unsaturated groups are selected from alkenyl or alkynyl groups present in the composition in an amount of from 40 wt. % to about 90 wt. % of the composition, alternatively from 45 to 85 wt. % of the composition, alternatively from 50 to 80 wt. % of the composition;
b) reinforcing silica filler; alternatively, fumed silica, colloidal silicas and/or a precipitated silica having a BET surface area of at least 50 m²/g (ISO 9277: 2010); alternatively, having surface areas of from 50 to 450 m²/g (ISO 9277: 2010), alternatively having surface areas of from 50 to 300 m²/g (BET method in accordance with ISO 9277: 2010), are typically used and are present in an amount of up to 50 wt. % of the composition, alternatively from 1.0 to 50 wt. % of the composition, alternatively of from 5.0 to 45 wt. % of the composition, alternatively of from 10.0 to 40 wt. % of the composition.
c) a linear or branched organopolysiloxane filler treating agent comprising multiple units of the structure:

—((R¹⁰)₂SiO)—,
where each R¹⁰ may be the same or different and is an alkyl group having from 1 to 10 carbons, alternatively an alkyl group having 1 to 6 carbons, alternatively is methyl, ethyl or propyl or is an aromatic group having from 6 to 12 carbons, alternatively phenyl, and the number average degree of polymerization is in a range of between 1 to 50, alternatively 1 to 25 and or where each terminal group comprises at least one hydroxyl or alkoxy; in an amount of from 0.1-20% wt. of the composition, alternatively 0.5 to 15 wt. % of the composition, alternatively 1 to 10 wt. % of the composition;
d) an organosilicon compound having at least two, alternatively at least three Si—H groups per molecule, component (b) present in an amount of from 0.1 to 10 wt. % of the hydrosilylation curable heat stabilised silicone rubber composition, alternatively 0.1 to 7.5 wt. % of the hydrosilylation curable heat stabilised silicone rubber composition, alternatively 0.5 to 7.5 wt. %, further alternatively from 0.5% to 5 wt. % of the hydrosilylation curable heat stabilised silicone rubber composition,
e) a heat stabiliser additive selected from one or more of dodecanedioic acid, bis[2-(2-hydroxybenzoyl)hydrazide], 1,2-di[-(3,5-di-tert-butvl-4-hydroxvp-henyl)propionyl]hydrazine, metal or non-metal phthalocyanine complexes, Salicyloylaminotriazole, triazole, benzotriazole, dilauryl 3,3′-thiodipropionate, ditridecyl 3,3′-thiodipropionatc, diphenyl sulfide and/or pentaerythritol beta-laurylthiopropionate; in an amount of from in an amount of from 0.001 to 5 wt. % of the composition, alternatively of from 0.01 to 5 wt. % of the composition, alternatively 0.01 to 3 wt. % of the composition; and
f) a hydrosilylation catalyst comprising or consisting of a platinum group metal or a compound thereof, in an amount dependent on the form/concentration in which the catalyst is provided, within the range of from 0.001 to 3.0 wt. % of the composition, alternatively from 0.001 to 2.5 wt. % of the composition, alternatively 0.01 to 2.0 wt. %, of the hydrosilylation curable heat stabilised silicone rubber composition.

The total wt. % of any combination of the components in the above composition is 100 wt. %.

The composition may also contain one or more of the above optional additives in amounts indicated again providing the total wt. % of the composition is 100 wt. %.

Mixtures of the aforementioned components (a), (d), and (f) may begin to cure at ambient temperature. Hence, the hydrosilylation curable heat stabilised silicone rubber compositions as hereinbefore described may be stored in two parts which are mixed together immediately before use when the composition is not prepared for immediate use. In such a case, the two parts are generally referred to as Part (A) and Part (B) and are designed to keep components (d) the cross-linker(s) and (f) the catalyst(s) apart to avoid premature cure.

Typically, in such cases a Part A composition will comprise components (a), (b), (c) and (f) and Part B will comprise components (a), (d), (b) and (c) and when present, inhibitor.

Other optional additives, when present in the composition, may be in either Part A or Part B providing they do not negatively affect the properties of any other component (e.g., catalyst inactivation). The part A and part B of a hydrosilylation curable heat stabilised silicone rubber composition are mixed together shortly prior to use to initiate cure of the full composition into a silicone elastomeric material. The compositions can be designed to be mixed in any suitable weight ratio e.g., part A:part B may be mixed together in any suitable weight ratios. Typically, the part A and part B compositions are mixed together using a two-roll mill or kneader mixer.

However, given component (a) is a silicone gum generally the composition is prepared by combining all of components together at ambient temperature into a one-part composition in cases where the composition is to be used immediately. Typically, a base is prepared first to enable the reinforcing silica fillers to be treated in-situ with component (c) and any other additional treating agents when additionally present and then the remaining ingredients can be introduced into the mixture in any suitable order.

Any mixing techniques and devices described in the prior art can be used for this purpose. The particular device to be used will be determined by the viscosities of components and the final curable coating composition. Suitable mixers include but are not limited to paddle type mixers e.g., planetary mixers and kneader type mixers. However, when component (a) is a gum mixing is preferably undertaken, as previously indicated using a kneader mixer. Cooling of components during mixing may be desirable to avoid premature curing of the composition.

There is also a process described herein for the preparation of a hydrosilylation cured heat stabilised silicone rubber comprising the steps of
(i) preparing a silicone rubber base composition comprising components (a), (b) and (c) as hereinbefore described,
(ii) mixing into the silicone rubber base of step (i) components (d), (e) and simultaneously or subsequently component (f); and
(iii) curing the composition.

Step (i) may be achieved by mixing together components (a) and (b) together with treating agent (c) at a temperature in the range of from 80° C. to 250° C., alternatively from 100° C. to 220° C., alternatively 120° C. to 200° C. for a period of from 30 minutes to 2 hours, alternatively 40 minutes to 2 hours, alternatively of from 45 minutes to 90 minutes, to ensure the reinforcing silica filler is in-situ treated with component (c) and thoroughly mixed into component (a). The resulting base may then be cooled to approximately room temperature (23° C. to 25° C.).

Components (d), (e) and simultaneously or subsequently component (f) the catalyst (catalyst composition e.g., Karstedt's catalyst) are then added as well as optional inhibitor (e.g., Ethynyl Cyclohexanol (ETCH)) and any other optional additives in any suitable order, or simultaneously and mixing to homogeneity.

Once prepared because of the reactivity of the components (a), (d) and (f) the composition will cure. Typically, cure will take place at a temperature between 80° C. and 180° C., alternatively between 100° C. and 170° C., alternatively between 120° C. and 170° C. This may take place in any suitable manner for example, the composition may be introduced into a mold and is then press cured for a suitable period of time, e.g., from 2 to 10 minutes or as otherwise desired or required. The present hydrosilylation curable heat stabilised silicone rubber composition may alternatively be further processed by injection moulding, encapsulation moulding, press moulding, dispenser moulding, extrusion moulding, transfer moulding, press vulcanization, centrifugal casting, calendaring, bead application or blow moulding. As and when required samples may be additionally post-cured by heating to a temperature of 130° C. to 200° C. for up to 4 hours.

In the case of a process for the manufacture of a two-part hydrosilylation curable heat stabilised silicone rubber composition as hereinbefore described the process may comprise the steps
(i) the same as step (i) for the preparation of the one-part composition above,
(ii) dividing the resulting mixture into two parts, part A and part B and introducing the catalyst (f) into part A and the cross-linker and inhibitor (if present) in the part B composition.
(iii) Introducing any other optional additives into either or both part A and part B;
(iv) Storing the part A and part B compositions separately.

Typically, when utilised the part A and part B compositions are thoroughly mixed in a suitable weight ratio as described above, e.g., in a weight ratio of about 1:100 immediately before use in order to avoid premature cure. Cure is then undertaken as described above for the one-part composition. Components in each of Part A and/or Part B may be mixed together individually or may be introduced into the composition in pre-prepared in combinations for, e.g., ease of mixing the final composition. For example, components (a) and (b) may be mixed together to form a base composition. In such cases component (c) the treating agent is usually introduced into the mixture so that the reinforcing silica filler (b) can be treated in-situ. Alternatively, the reinforcing silica filler (b) may be pre-treated with component (c) although this is not preferred. The resulting base material can be split into two or more parts, typically part A and part B and appropriate additional components and additives may be added, if and when required. There is also provided herein a use of additive e) as a or the heat stabilizer in a composition otherwise comprising components (a), (b), (c), (d) and (f) as herein before described. It was surprisingly found that additives (e) did not seemingly have any noticeable heat stabilising effect on liquid silicone rubber compositions utilising organopolysiloxane polymers which are not considered to be gums i.e. having viscosities of less than 1,000,000 mPa·s at 25° C., typically much less (>>) than 1,000,000 mPa·s at 25° C., e.g. having a viscosity of from 1000 mPa·s at 25° C. to 500,000 mPa·s at 25° C., alternatively 1000 mPa·s at 25° C. to 150,000 mPa·s at 25° C. (wherein the viscosities are measured as identified in the examples below). However, compositions as herein before described are able to improve elongation and tear after both short-term heat aging at 200° C. for 240 hours (h) and long-term heat aging at 180° C. for 3000 h heat aging to meet for example class E requirements with respect to ISO 6722 and LV 216 standards and furthermore is able to also pass post heat aging winding tests. This enables such compositions and the cured silicone rubber materials resulting therefrom in the Auto and cable markets as heat resistant rubber materials, for e.g., the outer sheath in electric cables e.g., for example high voltage power cable for electrical vehicles and high-speed trains, high heat resistant rubber for turbo charger hoses. In particular, they are suited for use in EV and HEVs given the increase in working voltage platform of EV and HEV battery modules and/or packs require the high voltage cables.

Hence, as previously discussed there is also provided herein an electrical power cable comprising
an electrically conductive core;
one or more layers of insulation around said core and
an outer sheath made from the heat stabilised silicone rubber being the cured product of the above composition.

There is also provided herein a method for preparing an electrical power cable comprising the step of applying and curing an outer sheath around the cable wherein said outer sheath is the cured product of the above composition hereinbefore described. Application may be by any suitable method, for example by extrusion. Hydrosilylation curable heat stabilised silicone rubber compositions may be used in a wide variety of applications, including for the sake of example in automotive and electronics applications as an outer sheath for an electrical power cable but also including as an outer sheath for an electrical power cable, conductor insulation, cable and outer sheath for electric vehicles, auto wire cable, industry wire cable for floor-heating systems, train and high speed train cables, high temperature resistance applications silicone rubber material, auto turbo charger hoses and jackets for high temperature industry apparatus.

### EXAMPLES

All viscosities were measured at 25° C. unless otherwise indicated. Viscosities of individual components in the following examples were measured using a TA instruments AR2000 Rheometer in plate-plate model at shear rate 10 s⁻¹ unless otherwise indicated. William's plasticity results were prepared in accordance with ASTM D-926-08. The number average molecular weight (Mn) values provided below were determined using a Waters 2695 Separations Module equipped with a vacuum degasser, and a Waters 2414 refractive index detector (Waters Corporation of MA, USA). The analyses were performed using certified grade toluene flowing at 1.0 mL/min as the eluent, using polystyrene calibration standards. Data collection and analyses were performed using Waters Empower™ GPC software (Waters Corporation of MA, USA).

A series of base compositions were prepared as shown in Table 1 below.

TABLE 1
Silicone rubber Base formulation (Wt. %)

| | | | | | | Base 6 |
|---|---|---|---|---|---|---|
| | Base 1 | Base 2 | Base 3 | Base 4 | Base 5 | (LSR) |
| Silicone Gum 1 | 44.37 | 57.43 | 57.13 | 57.43 | 57.43 | |
| Silicone Gum 2 | | 5.67 | 5.67 | 5.67 | 5.67 | |
| Silicone Gum 3 | 14.59 | | | | | |
| Polymer 1 | | | | | | 64.30 |
| Fumed Silica | 34.13 | 30.00 | 30.00 | 30.00 | 30.00 | 30.00 |
| Hydrophobing treating agent 1 | 5.89 | 6.50 | | | 3.25 | |
| Hydrophobing treating agent 2 | | | 6.50 | 6.50 | 3.25 | |
| Hydrophobing treating agent 3 | 1.02 | 0.40 | 0.70 | 0.40 | 0.40 | 0.70 |
| Hexamethyldisilazane | | | | | | 5.00 |

Silicone Gum 1 was dimethylvinyl terminated polydimethyl siloxane; having a vinyl content of 0.012 wt. %, a William's plasticity number of about 155 mm/100 and an Mn of 702,000; Silicone Gum 2 was dimethylvinyl terminated polydimethyl methylvinyl siloxane having a vinyl content of 0.725 wt. %, a William's plasticity number of about 147 mm/100 and an Mn of 700,000; Silicone Gum 3 dimethylvinyl terminated polydimethyl methylvinyl siloxane having a vinyl content of 0.0654 wt. %, a William's plasticity number of about 157 mm/100 and an Mn of 702,000; and Polymer 1 was dimethylvinyl terminated polydimethyl siloxane having a viscosity of 55,000mPa·s at 25° C. and a vinyl content of 0.088 wt. %

The fumed silica had a BET surface area of 270-330 m²/g tested in accordance with DIN ISO 9277 DIN 66132 (supplier details) and is commercially sold under the trade name HDK™ T30P by Wacker Chemie:
Hydrophobing treating agent 1 is HO(Me₂SiO)ₓH, x=1 to 18;
Hydrophobing treating agent 2 is HO(MePhSiO)ₓH, x=8 to 15; and
Hydrophobing treating agent 3 is HO(Me₂SiO)ₓ(MeViSiO)_{y}H, x+y=4 to 17

Silicone rubber base compositions of Table 1 were prepared by mixing the silicone gum, or silicone polymer (used in comparison in base 6), fumed silica and treatment agent(s) together in Kneader mixer, then base heating to a target temperature 170° C., and then was stripped approximately 120 minutes (min). The resulting base mixture was then cooling to room temperature. The fumed silica was hydrophobically treated in-situ using the identified hydrophobing treating agents during the base heating and stripping process.

Silicone rubber compositions were then prepared by taking 100 weight parts of the relevant base from Table 1 and introducing into said base the required amounts of the other ingredients in accordance with the compositions shown in Tables 2a to 2d other than the catalyst using a kneader mixer. The resulting mixture was then mixed with indicated amount of catalyst with a two-roll mill.

Base and additives are mixed to homogeneous in Kneader mixer with cooling water.

TABLE 2a
Silicone rubber compositions of comparative
Examples C. 1 to 6 in Wt %

| | C. 1 | C. 2 | C. 3 | C. 4 | C. 5 | C. 6 |
|---|---|---|---|---|---|---|
| BASE 1 | 97.8 | | | 97.7 | | |
| BASE 2 | | 97.8 | | | 97.7 | |
| BASE 3 | | | 97.8 | | | 97.7 |
| Heat Stabilizer | | | | 0.10 | 0.10 | 0.10 |
| (HS) 1 | | | | | | |
| Acid Scavenger | 1.00 | 1.00 | 1.00 | 1.00 | 1.00 | 1.00 |
| DCBP 50% | 1.20 | 1.20 | 1.20 | 1.20 | 1.20 | 1.20 |

Heat Stabilizer 1 is Dodecanedioic acid, bis[2-(2-hydroxy benzoyl)hydrazide];
The acid scavenger was a masterbatch of 34 wt. % magnesium oxide in silicone polymer;
DCBP 50% is a masterbatch comprising 50 wt. % of Bis-(2,4-dichlorobenzoyl) Peroxide, in silicone polymer.

TABLE 2b
Silicone rubber compositions of comparative
Examples C. 7 to 10 and Ex. 1 to 6 in wt. %.

| | C. 7 | C. 8 | C. 9 | C. 10 | Ex. 1 | Ex. 2 | Ex. 3 | Ex. 4 | Ex. 5 | Ex. 6 |
|---|---|---|---|---|---|---|---|---|---|---|
| BASE 2 | | 99.12 | | | | | | 99.02 | | |
| BASE 4 | 98.82 | | | 99.12 | 98.77 | 98.67 | 98.37 | | | 99.02 |
| BASE 5 | | | 99.12 | | | | | | 99.02 | |
| HS 1 | | | | | 0.05 | 0.15 | 0.45 | 0.10 | 0.10 | 0.10 |
| x-linker | 1.00 | 0.70 | 0.70 | 0.70 | 1.00 | 1.00 | 1.00 | 0.70 | 0.70 | 0.70 |
| ETCH | 0.03 | 0.03 | 0.03 | 0.03 | 0.03 | 0.03 | 0.03 | 0.03 | 0.03 | 0.03 |
| Catalyst | 0.15 | 0.15 | 0.15 | 0.15 | 0.15 | 0.15 | 0.15 | 0.15 | 0.15 | 0.15 |
| H/Vi ratio | 2.00 | 1.50 | 1.50 | 1.50 | 2.00 | 2.00 | 2.00 | 1.50 | 1.50 | 1.50 |

The cross-linker used throughout was trimethylsilyl terminated Dimethyl, methylhydrogen siloxane having a viscosity of 5mPa·s at 25° C.;
The catalyst used for all hydrosilylation cured cases was a Karstedt's catalyst (5,000 ppm Pt) in polydimethylsiloxane polymer;
ETCH is ethynyl cyclohexanol.

TABLE 2c
Silicone rubber compositions of comparative
Examples C. 11-14 and Ex. 7 to 10 in wt. %

| | C. 11 | Ex. 7 | Ex. 8 | Ex. 9 | Ex. 10 | Ex. 11 | Ex. 12 | C. 12 | C. 13 | C. 14 |
|---|---|---|---|---|---|---|---|---|---|---|
| BASE 3 | 98.82 | 98.77 | 98.62 | 98.32 | 97.82 | 98.62 | 98.62 | | | |
| Base 6 | | | | | | | | 91.0 | 90.9 | 90.5 |
| polymer 2 | | | | | | | | 6.45 | 6.45 | 6.45 |
| HS 1 | | | | | | | | | 0.10 | |
| HS 2 | | 0.05 | 0.20 | | | | | | | |
| HS 3 | | | | 0.50 | 1.00 | | | | | 0.50 |
| HS 4 | | | | | | 0.20 | | | | |
| HS 5 | | | | | | | 0.20 | | | |
| x-linker 1 | 1.00 | 1.00 | 1.00 | 1.00 | 1.00 | 1.00 | 1.00 | | | |
| X-linker 2 | | | | | | | | 2.20 | 2.20 | 2.20 |
| ETCH | 0.03 | 0.03 | 0.03 | 0.03 | 0.03 | 0.03 | 0.03 | 0.05 | 0.05 | 0.05 |
| Catalyst | 0.15 | 0.15 | 0.15 | 0.15 | 0.15 | 0.15 | 0.15 | 0.30 | 0.30 | 0.30 |
| H/Vi ratio | 2.00 | 2.00 | 2.00 | 2.00 | 2.00 | 2.00 | 2.00 | 1.50 | 1.50 | 1.50 |

Heat stabilizer (HS) 2 was 1,2-di[-(3,5-di-tert-butyl-4-hydroxyp-henyl)propionyl]hydrazine; and
Heat stabilizer (HS) 3 was copper (II) phthalocyanine, 40 wt. % in dimethylvinylteninated polydimethylsiloxane having a viscosity of 9000mPa·s at 25° C.;
Heat stabilizer (HS) 4 was Salicyloylaminotriazole; and
Heat stabilizer (HS) 5 was Pentaerythritol beta-laurylthiopropionate
Polymer 2 was a dimethylvinyl terminated polydimethyl methylvinyl siloxane having a viscosity of 350mPa·s at 25° C.; and
X-linker 2 was a trimethyl terminated Dimethyl, methylhydrogen siloxane having a viscosity of 50mPa·s at 25° C.

TABLE 2d
Silicone rubber compositions of comparative
Examples C. 15 to 18 and Ex. 13 to 16in wt. %

| Ingredient | C. 15 | C. 16 | C. 17 | C. 18 | Ex. 13 | Ex. 14 | Ex. 15 | Ex. 16 |
|---|---|---|---|---|---|---|---|---|
| BASE 4 | 98.62 | 98.62 | 98.62 | 98.62 | 98.57 | 98.57 | 98.57 | 98.57 |
| MnO | 0.50 | | | | 0.50 | | | |
| CeO₂ | | 0.50 | | | | 0.50 | | |
| TiO₂ | | | 0.50 | | | | 0.50 | |
| Fe₂O₃ | | | | 0.50 | | | | 0.50 |
| HS 1 | | | | | 0.05 | 0.05 | 0.05 | 0.05 |
| X-linker | 0.70 | 0.70 | 0.70 | 0.70 | 0.70 | 0.70 | 0.70 | 0.70 |
| ETCH | 0.03 | 0.03 | 0.03 | 0.03 | 0.03 | 0.03 | 0.03 | 0.03 |
| Catalyst | 0.15 | 0.15 | 0.15 | 0.15 | 0.15 | 0.15 | 0.15 | 0.15 |
| H/Vi ratio | 1.50 | 1.50 | 1.50 | 1.50 | 1.50 | 1.50 | 1.50 | 1.50 |

The resulting compositions were then molded into 2 mm sheet using compression molding and the result composition was then cured at 120° C., for a period of 10 min. No post cure was utilised.

Samples were then tested for their physical properties whilst other resulting cured sheets were then aged at the required temperatures for the required period of time. With respect to the physical property testing:
Shore A hardness was measured in accordance with ASTM D2240;
Tensile Strength, elongation at break and Modulus at 100% extension were measured in accordance with ASTM D412;
Specific gravity was measured in accordance with ASTM D792;
Tear strength was measured in accordance with ASTM D624 using DIE B; and
Tear was measured in accordance with ASTM D624 using Die C and a nick.

TABLE 3a(i)
Physical Property results for C. 1 to 6 after
curing at 120° C. for 10 minutes (min.)

| Tested Property | C. 1 | C. 2 | C. 3 | C. 4 | C. 5 | C. 6 |
|---|---|---|---|---|---|---|
| Shore A Hardness | 66 | 53 | 58 | 65 | 53 | 58 |
| Tensile strength (MPa) | 11.9 | 9.9 | 10.0 | 11.3 | 11.0 | 10.7 |
| Elongation at break (%) | 522 | 536 | 595 | 491 | 507 | 614 |
| Modulus @ 100% (MPa) | 2.00 | 1.51 | 1.60 | 1.97 | 1.80 | 1.59 |
| Tear strength Dic B (kN/m) | 25.87 | 25.38 | 32.12 | 26.03 | 29.01 | 32.68 |
| Specific gravity (g/cm³) | 1.194 | 1.165 | 1.182 | 1.194 | 1.165 | 1.181 |

Modulus @ 100% = modulus at 100% elongation

TABLE 3a(ii)
Physical Property results for C. 1 to 6 after subsequent
to heat aging at 200° C. for 240 hours

| Tested Property | C. 1 | C. 2 | C. 3 | C. 4 | C. 5 | C. 6 |
|---|---|---|---|---|---|---|
| Shore A Hardness | 81 | 61 | 68 | 79 | 62 | 66 |
| Tensile strength (MPa) | 5.8 | 7.0 | 5.9 | 7.5 | 7.2 | 7.1 |
| Elongation at break (%) | 236 | 366 | 382 | 341 | 345 | 421 |
| Modulus @ 100% (MPa) | 3.40 | 1.69 | 1.97 | 2.77 | 1.87 | 1.86 |
| Tear strength Die B (kN/m) | 10.32 | 17.54 | 20.49 | 12.72 | 18.36 | 25.51 |

Modulus @ 100% = modulus at 100% elongation

It can be seen that dodecanedioic acid, bis[2-(2-hydroxy benzoyl)hydrazide], i.e., Heat Stabilizer 1 does not provide heat stability to the peroxide cured examples in Table 3a.

TABLE 3b(i)
Physical Property results for C. 7 to 10 and C.12 to 14 after curing at 120° C. for 10 min

| Tested Property | C. 7 | C. 8 | C. 9 | C. 10 | C. 12 | C. 13 | C. 14 |
|---|---|---|---|---|---|---|---|
| Shore A Hardness | 64 | 61 | 61 | 65 | 64 | 66 | 66 |
| Tensile strength (MPa) | 10.89 | 10.20 | 10.82 | 10.37 | 10.5 | 10.7 | 10.9 |
| Elongation at break (%) | 929 | 879 | 908 | 959 | 393 | 388 | 412 |
| Modulus @ 100% (MPa) | 2.43 | 2.66 | 2.31 | 2.48 | 3.50 | 3.65 | 3.57 |
| Tear strength Dic B (kN/m) | 52.41 | 47.77 | 51.58 | 56.35 | 33.02 | 34.38 | 36.82 |
| Tear (kN/m) | 49.99 | 45.57 | 45.74 | 49.90 | | | |
| Specific gravity (g/cm³) | 1.170 | 1.169 | 1.172 | 1.176 | 1.143 | 1.143 | 1.142 |

TABLE 3b(ii)
Physical Property results for C. 7 to 10 and C.12 to 14
after subsequent to heat aging at 200° C. for 240 hours

| Tested Property | C. 7 | C. 8 | C. 9 | C. 10 | C. 12 | C. 13 | C. 14 |
|---|---|---|---|---|---|---|---|
| Shore A Hardness | 73 | 72 | 70 | 71 | 67 | 65 | 65 |
| Tensile strength (MPa) | 7.27 | 6.57 | 8.05 | 8.75 | 8.8 | 8.6 | 8.9 |
| Elongation at break (%) | 487 | 429 | 525 | 632 | 271 | 283 | 297 |
| Modulus @ 100% (MPa) | 3.15 | 3.02 | 3.10 | 3.06 | 4.20 | 3.79 | 3.85 |
| Tear strength Die B (kN/m) | 35.97 | 21.88 | 32.10 | 39.92 | 9.93 | 12.22 | 14.98 |
| Tear (kN/m) | 23.46 | 21.43 | 32.53 | 37.99 | | | |

Similarly to Table 3a, the results in Table 3b show that in the absence of dodecanedioic acid, bis[2-(2-hydroxy benzoyl)hydrazide](heat stabilizer 1) there is a distinct lack of heat stability in the cured product after heat aging at 200° C. for 240 hours. C.12, C.13 and C.14 clearly show that the additives HS. 1 and HS. 3 do not have a positive effect for heat stability on the polymer 1 (base 6) composition i.e., with a polymer of much lower viscosity than the silicone gums in accordance with the description herein. This was considered surprising.

TABLE 3c(i)
Physical Property results for Ex. 1 to 6 after curing at 120° C. for 10 min

| Tested Property | Ex. 1 | Ex. 2 | Ex. 3 | Ex. 4 | Ex. 5 | Ex. 6 |
|---|---|---|---|---|---|---|
| Shore A Hardness | 64 | 64 | 65 | 62 | 61 | 63 |
| Tensile strength (MPa) | 10.32 | 10.57 | 10.40 | 10.03 | 11.01 | 11.07 |
| Elongation at break (%) | 935 | 939 | 937 | 852 | 927 | 968 |
| Modulus @ 100% (MPa) | 2.38 | 2.38 | 2.48 | 2.32 | 2.26 | 2.28 |
| Tear strength Die B (kN/m) | 53.88 | 54.81 | 53.82 | 50.17 | 49.37 | 53.25 |
| Tear (kN/m) | 46.85 | 46.56 | 47.83 | 45.65 | 41.34 | 44.09 |
| Specific gravity (g/cm³) | 1.169 | 1.169 | 1.169 | 1.168 | 1.173 | 1.176 |

TABLE 3c(ii)
Physical Property results for Ex. 1 to 6 after subsequent
to heat aging at 200° C. for 240 hours

| Tested Property | Ex. 1 | Ex. 2 | Ex. 3 | Ex. 4 | Ex. 5 | Ex. 6 |
|---|---|---|---|---|---|---|
| Shore A Hardness | 70 | 70 | 70 | 68 | 66 | 68 |
| Tensile strength (MPa) | 7.87 | 8.03 | 8.09 | 7.05 | 8.38 | 8.65 |
| Elongation at break (%) | 682 | 673 | 691 | 591 | 688 | 709 |
| Modulus @ 100% (MPa) | 2.91 | 2.85 | 2.90 | 2.74 | 2.60 | 2.68 |
| Tear strength Die B (kN/m) | 38.80 | 37.45 | 38.26 | 33.07 | 35.80 | 41.59 |
| Tear (kN/m) | 37.79 | 37.68 | 39.65 | 31.08 | 38.77 | 42.25 |

The results of Table 3c show that the presence of dodccanedioic acid, bis[2-(2-hydroxy benzol)hydrazide](heat stabilizer 1) in the composition has made a significant improvement in heat stability particularly with respect to the elongation and tear strength after aging at (%1 over a period of 240 hours.

TABLE 3d(i)
Physical Property results for C. 11 and Ex. 7 to 10 after curing at 120° C. for 10 min

| Tested Property | C. 11 | Ex. 7 | Ex. 8 | Ex. 9 | Ex. 10 | Ex. 11 | Ex. 12 |
|---|---|---|---|---|---|---|---|
| Shore A Hardness | 65 | 65 | 64 | 63 | 61 | 64 | 64 |
| Tensile strength (MPa) | 10.1 | 9.7 | 9.5 | 10.3 | 9.0 | 10.0 | 10.2 |
| Elongation at break (%) | 810 | 807 | 811 | 860 | 890 | 939 | 918 |
| Modulus @ 100% (MPa) | 2.45 | 2.39 | 2.39 | 2.36 | 1.99 | 2.00 | 2.10 |
| Tear strength Die B (kN/m) | 51.37 | 47.85 | 45.34 | 47.96 | 49.07 | 49.57 | 50.15 |
| Specific gravity (g/cm³) | 1.178 | 1.177 | 1.177 | 1.177 | 1.176 | 1.185 | 1.183 |

TABLE 3d(ii)
Physical Property results for C. 11 and Ex. 7 to 12 after
subsequent to heat aging at 200° C. for 240 hours

| Tested Property | C. 11 | Ex. 7 | Ex. 8 | Ex. 9 | Ex. 10 | Ex. 11 | Ex. 12 |
|---|---|---|---|---|---|---|---|
| Shore A Hardness | 76 | 76 | 75 | 73 | 70 | 70 | 72 |
| Tensile strength (MPa) | 6.42 | 5.87 | 5.99 | 7.05 | 6.67 | 7.49 | 6.10 |
| Elongation at break (%) | 386 | 415 | 460 | 590 | 605 | 659 | 545 |
| Modulus @ 100% (MPa) | 3.30 | 3.22 | 3.07 | 2.93 | 2.59 | 2.61 | 2.94 |
| Tear strength Die B (kN/m) | 14.98 | 14.87 | 17.22 | 21.50 | 32.65 | 35.73 | 23.86 |

It can be seen from the results depicted in Tables 3d(i) and (ii) that 1,2-di[-(3,5-di-tert-butyl-4-hydroxyp-henyl)propionyl]hydrazine (heat stabilizer 2), copper (11) phthalocyanine, 40 wt. % in dimethylvinylterminated polydimethylsiloxane having a viscosity of 9000mPa·s at 25° C. (heat stabilizer 3), salicyloylaminotriazole (heat stabilizer 4) and pentaerythritol beta-laurylthiopropionate (heat stabilizer 5) improve heat stability in hydrosilylation cured systems by improving elongation and tear strength after aging at 200° C. over a period of 240 hours.

TABLE 4a(i)
Physical Property results for C. 10 and C.
15 to 18 after curing at 120° C. for 10 min

| Tested Property | C. 10 | C. 15 | C. 16 | C. 17 | C. 18 |
|---|---|---|---|---|---|
| Shore A Hardness | 65 | 61 | 61 | 62 | 67 |
| Tensile strength (MPa) | 10.37 | 10.56 | 10.69 | 11.39 | 10.57 |
| Elongation at break (%) | 959 | 960 | 991 | 985 | 929 |
| Modulus @ 100% (MPa) | 2.48 | 2.14 | 2.08 | 2.18 | 2.43 |
| Tear strength Die B | 56.35 | 52.43 | 51.49 | 52.09 | 57.63 |
| (kN/m) | | | | | |
| Tear (kN/m) | 49.90 | 43.76 | 45.61 | 51.51 | 48.14 |
| Specific gravity (g/cm³) | 1.176 | 1.186 | 1.184 | 1.181 | 1.180 |

TABLE 4a(ii)
Physical Property results for C. 10 and C. 15 to 18
subsequent to heat aging at 200° C. for 240 hours

| Tested Property | C. 10 | C. 15 | C. 16 | C. 17 | C. 18 |
|---|---|---|---|---|---|
| Shore A Hardness | 71 | 70 | 70 | 70 | 73 |
| Tensile strength (MPa) | 8.75 | 9.11 | 9.33 | 9.15 | 9.5 |
| Elongation at break (%) | 632 | 617 | 646 | 611 | 671 |
| Modulus @, 100% | 3.06 | 2.93 | 2.92 | 3.07 | 3.04 |
| (MPa) | | | | | |
| Tear strength (kN/m) | 41.59 | 38.79 | 42.35 | 44.22 | 45.92 |

TABLE 4b
Physical Property results for C. 10 and C. 15 to 18 after
curing at 120° C. for 10 min and then subsequent
heat aging at 180° C. for 1000, 2000 and 3000 hours

| Tested Property | C. 10 | C. 15 | C. 16 | C. 17 | C. 18 |
|---|---|---|---|---|---|
| Aged, 180° C./1000 | | | | | |
| hours | | | | | |
| Shore A Hardness | 73 | 74 | 73 | 74 | 73 |
| Tensile strength (MPa) | 7.49 | 8.29 | 7.90 | 7.66 | 7.85 |
| Elongation at break (%) | 481 | 527 | 500 | 505 | 499 |
| Modulus @ 100% (MPa) | 3.14 | 3.09 | 3.12 | 3.08 | 3.22 |
| Tear strength Die B | 34.23 | 29.08 | 27.12 | 28.52 | 30.78 |
| (kN/m) | | | | | |
| Aged, 180° C./2000 | | | | | |
| hours | | | | | |
| Shore A Hardness | 73 | 72 | 73 | 73 | 73 |
| Tensile strength (MPa) | 5.74 | 6.55 | 6.47 | 5.28 | 5.51 |
| Elongation at break (%) | 377 | 446 | 419 | 336 | 358 |
| Modulus @ 100% (MPa) | 3.30 | 2.91 | 3.12 | 3.15 | 3.16 |
| Tear strength Die B | 19.98 | 19.41 | 22.49 | 22.07 | 21.29 |
| (kN/m) | | | | | |
| Aged, 180° C./3000 | | | | | |
| hours | | | | | |
| Shore A Hardness | 74 | 75 | 73 | 76 | 75 |
| Tensile strength (MPa) | 3.76 | 4.67 | 3.93 | 3.77 | 3.88 |
| Elongation at break (%) | 201 | 322 | 246 | 195 | 208 |
| Modulus @ 100% (MPa) | 3.20 | 3.16 | 3.01 | 3.28 | 3.23 |
| Tear strength (kN/m) | 17.76 | 15.81 | 14.92 | 14.59 | 18.56 |

TABLE 4c(i)
Physical Property results for Ex. 6 and Ex.
13 to 16 after curing at 120° C. for 10 min

| Tested Property | Ex. 6 | Ex. 13 | Ex. 14 | Ex. 15 | Ex. 16 |
|---|---|---|---|---|---|
| Shore A Hardness | 63 | 63 | 61 | 61 | 67 |
| Tensile strength (MPa) | 11.07 | 10.74 | 11.07 | 11.07 | 10.88 |
| Elongation at brcak (%) | 968 | 975 | 986 | 995 | 940 |
| Modulus @ 100% (MPa) | 2.28 | 2.21 | 2.11 | 2.13 | 2.51 |
| Tear strength Die B | 53.25 | 56.15 | 54.41 | 54.33 | 53.94 |
| (kN/m) | | | | | |
| Tear (kN/m) | 44.09 | 45.96 | 47.27 | 42.02 | 47.22 |
| Specific gravity (g/cm³) | 1.176 | 1.185 | 1.184 | 1.184 | 1.180 |

TABLE 4c(ii)
Physical Property results for Ex. 6 and Ex. 13 to 16
after subsequent heat aging at 200° C. for 240 hours

| Tested Property | Ex. 6 | Ex. 13 | Ex. 14 | Ex. 15 | Ex. 16 |
|---|---|---|---|---|---|
| Shore A Hardness | 68 | 69 | 69 | 68 | 72 |
| Tensile strength (MPa) | 8.65 | 10.45 | 9.66 | 9.81 | 9.71 |
| Elongation at break (%) | 709 | 792 | 710 | 777 | 754 |
| Modulus @ 100% (MPa) | 2.68 | 2.70 | 2.75 | 2.64 | 2.85 |
| Tear strength Die B | 39.92 | 41.77 | 37.36 | 41.79 | 39.98 |
| (kN/m) | | | | | |

TABLE 4d
Physical Property results for Ex. 6 and Ex. 13 to 16
after curing at 120° C. for 10 min and then subsequent
heat aging at 180° C. for 1000, 2000 and 3000 hours

| Tested Property | Ex. 6 | Ex. 13 | Ex. 14 | Ex. 15 | Ex. 16 |
|---|---|---|---|---|---|
| Aged, 180° C./1000 | | | | | |
| hours | | | | | |
| Shore A Hardness | 72 | 72 | 73 | 72 | 72 |
| Tensile strength (MPa) | 8.48 | 8.67 | 7.88 | 8.19 | 8.26 |
| Elongation at break (%) | 594 | 621 | 580 | 618 | 593 |
| Modulus @ 100% (MPa) | 3.00 | 2.89 | 3.11 | 2.92 | 2.90 |
| Tear strength Die B | 42.90 | 42.51 | 38.19 | 42.26 | 41.63 |
| (kN/m) | | | | | |
| Aged, 180° C./2000 | | | | | |
| hours | | | | | |
| Shore A Hardness | 72 | 72 | 73 | 73 | 72 |
| Tensile strength (MPa) | 6.52 | 7.00 | 6.45 | 6.35 | 7.00 |
| Elongation at break (%) | 490 | 528 | 484 | 522 | 551 |
| Modulus @ 100% (MPa) | 2.98 | 2.97 | 3.20 | 2.97 | 2.84 |
| Tear strength Die B | 31.54 | 30.02 | 28.97 | 31.13 | 28.14 |
| (kN/m) | | | | | |
| Aged, 180° C./3000 | | | | | |
| hours | | | | | |
| Shore A Hardness | 74 | 74 | 76 | 75 | 73 |
| Tensile strength (MPa) | 4.50 | 5.14 | 4.50 | 3.88 | 5.11 |
| Elongation at break (%) | 354 | 413 | 340 | 305 | 418 |
| Modulus @ 100% (MPa) | 3.09 | 3.04 | 3.28 | 3.12 | 3.03 |
| Tear strength Die B | 21.92 | 18.55 | 18.06 | 19.56 | 20.97 |
| (kN/m) | | | | | |

It can be seen after comparing the results in Tables 4a to that with metal oxides also in formulation dodecanedioic acid, bis[2-(2-hydroxy benzoyl)hydrazide]; Heat Stabilizer 1 also works for platinum cure system to improve elongation and tear strength after short term heat aging at 200° C. for 240 hours and long-term aging at 180° C. for 1000, 2000 and 3000 hours.

1. A hydrosilylation curable heat stabilised silicone rubber composition comprising:
a) an organopolysiloxane polymer having a William's plasticity of at least 100 mm/100 measured in accordance with ASTM D-926-08, and at least two unsaturated groups per molecule, where the unsaturated groups are selected from alkenyl or alkynyl groups;
b) reinforcing silica filler;
c) a linear or branched organopolysiloxane filler treating agent comprising multiple units of the structure:
—((R¹⁰)₂SiO)—,
where each R¹⁰ may be the same or different and is an alkyl group having from 1 to 10 carbons, optionally from 1 to 6 carbons, or is an aromatic group having from 6 to 12 carbons, and the number average degree of polymerization is in a range of between 1 to 50, and where each terminal group comprises at least one hydroxyl or alkoxy;
d) an organosilicon compound having at least two, optionally at least three, Si—H groups per molecule,
e) a heat stabiliser additive selected from one or more of dodecanedioic acid, bis[2-(2-hydroxybenzoyl)hydrazide], 1,2-di[-(3,5-di-tert-butyl-4-hydroxyphenyl)propionyl]hydrazine, metal or non-metal phthalocyanine complexes, salicyloylaminotriazole, triazole, benzotriazole, dilauryl 3,3′-thiodipropionate, ditridecyl 3,3′-thiodipropionate, diphenyl sulfide, and/or pentaerythritol beta-laurylthiopropionate; and
f) a hydrosilylation catalyst comprising, or consisting of, a platinum group metal or a compound thereof.

2. The hydrosilylation curable heat stabilised silicone rubber composition in accordance with claim 1, further comprising a cure inhibitor.

3. The hydrosilylation curable heat stabilised silicone rubber composition in accordance with claim 1, wherein component c) is present in an amount of from 0.1 to 10 wt. % of the composition.

4. The hydrosilylation curable heat stabilised silicone rubber composition in accordance with claim 1, wherein component e) is present in an amount of from 0.001 to 5.0 wt. % of the composition.

5. The hydrosilylation curable heat stabilised silicone rubber composition in accordance with claim 1, further comprising one or more additives selected from compression set additives, additional hydrophobic treating agents other than component c), pigments and/or coloring agents, pot life extenders, flame retardants, mold release agents, UV light stabilizers, bactericides, and mixtures thereof.

6. The hydrosilylation curable heat stabilised silicone rubber composition in accordance with claim 1, wherein component a) has a William's plasticity of at least 125 mm/100 measured in accordance with ASTM D-926-08.

7. A silicone-based product cured from the hydrosilylation curable heat stabilised silicone rubber composition in accordance with claim 1.

8. The silicone-based product in accordance with claim 7, which passes class E with respect to ISO 6722 and LV 216 standards.

9. A process for the preparation of a hydrosilylation cured heat stabilised silicone rubber, the process comprising the steps of;
(i) preparing a silicone rubber base composition comprising:
a) an organopolysiloxane polymer having a William's plasticity of at least 100 mm/100 measured in accordance with ASTM D-926-08, and at least two unsaturated groups per molecule, where the unsaturated groups are selected from alkenyl or alkynyl groups;
b) reinforcing silica filler; and
c) a linear or branched organopolysiloxane filler treating agent comprising multiple units of the structure:
—((R¹⁰)₂SiO)—,
where each R¹⁰ may be the same or different and is an alkyl group having from 1 to 10 carbons, optionally from 1 to 6 carbons, or is an aromatic group having from 6 to 12 carbons, and the number average degree of polymerization is in a range of between 1 to 50, and where each terminal group comprises at least one hydroxyl or alkoxy;
(ii) mixing into the silicone rubber base composition of step (i);
d) an organosilicon compound having at least two, optionally at least three, Si—H groups per molecule;
e) a heat stabiliser additive selected from one or more of dodecanedioic acid, bis[2-(2-hydroxybenzoyl)hydrazide], 1,2-di[-(3,5-di-tert-butyl-4-hydroxyphenyl)propionyl]hydrazine, metal or non-metal phthalocyanine complexes, salicyloylaminotriazole, triazole, benzotriazole, dilauryl 3,3′-thiodipropionate, ditridecyl 3,3′-thiodipropionate, diphenyl sulfide, and/or pentaerythritol beta-laurylthiopropionate;
and simultaneously or subsequently
f) a hydrosilylation catalyst comprising, or consisting of, a platinum group metal or a compound thereof; and
(iii) curing the composition.

10. A silicone-based product obtained, or obtainable by, the process in accordance with claim 9.

11. (canceled)

12. An electrical power cable comprising:
an electrically conductive core;
one or more layers of insulation around the electrically conductive core; and
an outer sheath made from a heat stabilised silicone rubber being a cured product of the hydrosilylation curable heat stabilised silicone rubber composition in accordance with claim 1.

13. An outer sheath for an electrical power cable formed from the hydrosilylation curable heat stabilised silicone rubber composition in accordance with claim 1.

14. A method for preparing an electrical power cable, the method comprising:
applying and curing an outer sheath around the electrical power cable;
wherein the outer sheath is a cured product of the hydrosilylation curable heat stabilised silicone rubber composition in accordance with claim 1.

15. The process for the preparation of a hydrosilylation cured heat stabilised silicone rubber in accordance with claim 9, wherein the hydrosilylation curable heat stabilised silicone rubber composition further comprises a cure inhibitor.

16. The process for the preparation of a hydrosilylation cured heat stabilised silicone rubber in accordance with claim 9, component c) is present in the hydrosilylation curable heat stabilised silicone rubber composition in an amount of from 0.1 to 10 wt. % of the composition.

17. The process for the preparation of a hydrosilylation cured heat stabilised silicone rubber in accordance with claim 9, wherein component e) is present in the hydrosilylation curable heat stabilised silicone rubber composition in an amount of from 0.001 to 5.0 wt. % of the composition.

18. The process for the preparation of a hydrosilylation cured heat stabilised silicone rubber in accordance with claim 9, wherein the hydrosilylation curable heat stabilised silicone rubber composition further comprises one or more additives selected from compression set additives, additional hydrophobic treating agents other than component c), pigments and/or coloring agents, pot life extenders, flame retardants, mold release agents, UV light stabilizers, bactericides, and mixtures thereof.

19. The process for the preparation of a hydrosilylation cured heat stabilised silicone rubber in accordance with claim 9, wherein component a) has a William's plasticity of at least 125 mm/100 measured in accordance with ASTM D-926-08.
